(19) United States
(12) Patent Application Publication
(10) Pub. No.: US 2006/0264557 A1
(43) Pub. Date: Nov. 23, 2006

(54) In-line compounding and molding process for making fiber reinforced polypropylene composites

(76) Inventors: Arnold Lustiger, Edison, NJ (US); Jeffrey Valentage, Royal Oak, MI (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 11/435,578

(22) Filed: May 17, 2006

Related U.S. Application Data
(63) Continuation-in-part of application No. 11/395,493, filed on Mar. 31, 2006.
Application No. 11/395,493 is a continuation-in-part of application No. 11/318,363, filed on Dec. 23, 2005.
Application No. 11/318,363 is a continuation-in-part of application No. 11/301,533, filed on Dec. 13, 2005.
(60) Provisional application No. 60/681,609, filed on May 17, 2005.

(51) Int. Cl. C08K 3/34

(52) U.S. Cl. 524/451; 524/456

(57) ABSTRACT

The present invention is directed to an in-line compounding and molding process for making fiber reinforced polypropylene composite parts and articles that exhibit beneficial mechanical and aesthetic properties imparted by such process and compositions. The in-line compounding and molding process includes the steps of providing an in-line compounding and molding machine comprising a twin screw extruder fluidly coupled to an injection molder; extrusion compounding in the twin screw extruder a composition comprising at least 30 wt % polypropylene, from 10 to 60 wt % organic fiber, from 0 to 40 wt % inorganic filler, and from 0 to 0.1 wt % lubricant to form a melt extrudate; conveying the melt extrudate to the injection molder; and molding the melt extrudate in the injection molder to form a part or article. Fiber reinforced polypropylene articles formed from the in-line compounding and molding process have flexural modulus of at least 300,000 psi and exhibit ductility during instrumented impact testing. Fiber reinforced polypropylene articles formed from the process of the present invention are particularly suitable for making household appliances, automotive parts, and boat hulls.

### CROSS-REFERENCE TO RELATED APPLICATION

This application is a Continuation-in-Part of U.S. patent application Ser. No. 11/395,493 filed Mar. 31, 2006, which is a Continuation-in-Part of U.S. patent application Ser. No. 11/318,363 filed Dec. 23, 2005, which is also a Continuation-in-Part of U.S. patent application Ser. No. 11/301,533 filed Dec. 13, 2005, and claims priority of U.S. Provisional Application 60/681,609 filed May 17, 2005, the contents of each are hereby incorporated by reference.

### FIELD OF THE INVENTION

The present invention is directed generally to articles made from fiber reinforced polypropylene compositions having a flexural modulus of at least 300,000 psi and exhibiting ductility during instrumented impact testing. It more particularly relates to an advantageous process for making fiber reinforced polypropylene composites. Still more particularly, the present invention relates to an in-line compounding and molding process for making parts of fiber reinforced polypropylene composites.

### BACKGROUND OF THE INVENTION

Polyolefins have limited use in engineering applications due to the tradeoff between toughness and stiffness. For example, polyethylene is widely regarded as being relatively tough, but low in stiffness. Polypropylene generally displays the opposite trend, i.e., is relatively stiff, but low in toughness.

Several well known polypropylene compositions have been introduced which address toughness. For example, it is known to increase the toughness of polypropylene by adding rubber particles, either in-reactor resulting in impact copolymers, or through post-reactor blending. However, while toughness is improved, the stiffness is considerably reduced using this approach.

Glass reinforced polypropylene compositions have been introduced to improve stiffness. However, the glass fibers have a tendency to break in typical injection molding equipment, resulting in reduced toughness and stiffness. In addition, glass reinforced products have a tendency to warp after injection molding

Another known method of improving physical properties of polyolefins is organic fiber reinforcement. For example, EP Patent Application 0397881, the entire disclosure of which is hereby incorporated herein by reference, discloses a composition produced by melt-mixing 100 parts by weight of a polypropylene resin and 10 to 100 parts by weight of polyester fibers having a fiber diameter of 1 to 10 deniers, a fiber length of 0.5 to 50 mm and a fiber strength of 5 to 13 g/d, and then molding the resulting mixture. Also, U.S. Pat. No. 3,639,424 to Gray, Jr. et al., the entire disclosure of which is hereby incorporated herein by reference, discloses a composition including a polymer, such as polypropylene, and uniformly dispersed therein at least about 10% by weight of the composition staple length fiber, the fiber being of man-made polymers, such as poly(ethylene terephthalate) or poly(1,4-cyclohexylenedimethylene terephthalate).

Fiber reinforced polypropylene compositions are also disclosed in PCT Publication WO02/053629, the entire disclosure of which is hereby incorporated herein by reference. More specifically, WO02/053629 discloses a polymeric compound, comprising a thermoplastic matrix having a high flow during melt processing and polymeric fibers having lengths of from 0.1 mm to 50 mm. The polymeric compound comprises between 0.5 wt % and 10 wt % of a lubricant.

Various modifications to organic fiber reinforced polypropylene compositions are also known. For example, polyolefins modified with maleic anhydride or acrylic acid have been used as the matrix component to improve the interface strength between the synthetic organic fiber and the polyolefin, which was thought to enhance the mechanical properties of the molded product made therefrom.

Other background references include PCT Publication WO90/05164; EP Patent Application 0669372; U.S. Pat. No. 6,395,342 to Kadowaki et al.; EP Patent Application 1075918; U.S. Pat. No. 5,145,891 to Yasukawa et al., U.S. Pat. No. 5,145,892 to Yasukawa et al.; and EP Patent 0232522, the entire disclosures of which are hereby incorporated herein by reference.

U.S. Pat. No. 3,304,282 to Cadus et al. discloses a process for the production of glass fiber reinforced high molecular weight thermoplastics in which the plastic resin is supplied to an extruder or continuous kneader, endless glass fibers are introduced into the melt and broken up therein, and the mixture is homogenized and discharged through a die. The glass fibers are supplied in the form of endless rovings to an injection or degassing port downstream of the feed hopper of the extruder.

U.S. Pat. No. 5,401,154 to Sargent discloses an apparatus for making a fiber reinforced thermoplastic material and forming parts therefrom. The apparatus includes an extruder having a first material inlet, a second material inlet positioned downstream of the first material inlet, and an outlet. A thermoplastic resin material is supplied at the first material inlet and a first fiber reinforcing material is supplied at the second material inlet of the compounding extruder, which discharges a molten random fiber reinforced thermoplastic material at the extruder outlet. The fiber reinforcing material may include a bundle of continuous fibers formed from a plurality of monofilament fibers. Fiber types disclosed include glass, carbon, graphite and Kevlar.

U.S. Pat. No. 5,595,696 to Schlarb et al. discloses a fiber composite plastic and a process for the preparation thereof and more particularly to a composite material comprising continuous fibers and a plastic matrix. The fiber types include glass, carbon and natural fibers, and can be fed to the extruder in the form of chopped or continuous fibers. The continuous fiber is fed to the extruder downstream of the resin feed hopper.

U.S. Pat. No. 6,395,342 to Kadowaki et al. discloses an impregnation process for preparing pellets of a synthetic organic fiber reinforced polyolefin. The process comprises the steps of heating a polyolefin at the temperature which is higher than the melting point thereof by 40 degree C. or more to lower than the melting point of a synthetic organic fiber to form a molten polyolefin; passing a reinforcing fiber comprising the synthetic organic fiber continuously through the molten polyolefin within six seconds to form a polyolefin impregnated fiber; and cutting the polyolefin impregnated fiber into the pellets. Organic fiber types include polyethylene terephthalate, polybutylene terephthalate, polyamide 6, and polyamide 66.

U.S. Pat. No. 6,419,864 to Scheuring et al. discloses a method of preparing filled, modified and fiber reinforced thermoplastics by mixing polymers, additives, fillers and fibers in a twin screw extruder. Continuous fiber rovings are fed to the twin screw extruder at a fiber feed zone located downstream of the feed hopper for the polymer resin. Fiber types disclosed include glass and carbon.

Consistently feeding PET fibers into a compounding extruder is an issue encountered during the production of PP-PET fiber composites. Gravimetric or vibrational feeders are used in the metering and conveying of polymers, fillers and additives into the extrusion compounding process. These feeders are designed to convey materials at a constant rate using a single or twin screw by measuring the weight loss in the hopper of the feeder. These feeders are effective in conveying pellets or powder, but are not effective in conveying cut fiber. Cut fiber tends to bridge and entangle in these feeders resulting in an inconsistent feed rate to the compounding process. More particularly, at certain times, fiber gets hung up in the feeder and little is conveyed, while at other times, an overabundance of fiber is conveyed to the compounding extruder.

Another issue encountered during the production of PP-PET fiber composites is adequately dispersing the PET fibers into the PP matrix while still maintaining the advantageous mechanical properties imparted by the incorporation of the PET fibers. More particularly, extrusion compounding screw configuration may impact the dispersion of PET fibers within the PP matrix, and extrusion compounding processing conditions may impact not only the mechanical properties of the matrix polymer, but also the mechanical properties of the PET fibers.

Interior automotive parts often require a unique combination of toughness, stiffness and aesthetics. Many of these parts are based on polypropylene copolymers with various additives to achieve this desired combination of properties. Polypropylene homopolymer is typically stiff, but too brittle for many of these applications. As result, various rubbers, including ethylene-propylene diene rubber, are incorporated to increase toughness, either in the polymerization reactor to synthesize a so-called impact copolymer, or through blending.

Many interior automotive parts also require a cloth-like appearance and feel. To create such a cloth-like look in polypropylene (PP) or thermoplastic olefin TPO) materials, various fiber based additives are added to a base polymer product. Typically the base material is a light gray color and the fiber based additives are a darker gray or blue color to create the cloth-like effect. However, the presence of these fibers causes a significant decrease in impact properties. To counter balance the loss of impact resistance, typically plastomers or ethylene-propylene-diene rubber (EPDM) are added. However these modifiers also lower the stiffness (flexural modulus) of the product, and substantially increase the raw material cost.

In the production of parts molded from fiber reinforced polypropylene composites, the compounding step to incorporate fiber, filler and other additives into polypropylene based polymer is separate from the process to injection mold a part from the fiber reinforced polypropylene composite. This results in the need to ship, handle and store resin produced from the compounding process before it is used in a subsequent injection molding process. In addition, the fiber reinforced polypropylene composite resin undergoes a second heat history when being melted during the subsequent injection molding process, which may negatively affect the properties of the resulting part because of the properties of the reinforcing fiber being impacted. In addition, properties may be negatively impacted by the second heat history because of the molecular weight of the polypropylene being reduced due to thermal degradation. Furthermore, the decoupling of the compounding process and the injection molding process decreases the flexibility available to the molder for altering the properties of molded parts via changes to the formulation of the fiber reinforced polypropylene composite (i.e. by adding more or less fiber or more or less filler).

A need exists for an improved method for making fiber reinforced polypropylene composites, and in particular, a process that may be used to both incorporate fiber and filler into the polypropylene based resin as well as mold a part from the resulting blend without having to produce an intermediate resin. In addition, a need exists for an improved method for making fiber reinforced polypropylene composites, and in particular, compounding polypropylene based resin, organic fiber, filler, and other additives in the same process as injection molding a part from the blend such that the molded part includes a uniform distribution of cut fiber which has only undergone one heat history in order to improve the properties of the molded parts.

### SUMMARY OF THE INVENTION

It has surprisingly been found that substantially lubricant-free fiber reinforced polypropylene compositions can be made which simultaneously have a flexural modulus of at least 300,000 psi and exhibit ductility during instrumented impact testing. Particularly surprising is the ability to make such compositions using a wide range of polypropylenes as the matrix material, including some polypropylenes that without fiber are very brittle. The compositions of the present invention are particularly suitable for making articles including, but not limited to household appliances, automotive parts, and boat hulls. It has also been surprisingly found that organic fiber may be fed into a twin screw compounding extruder coupled to an injection molding machine by continuously unwinding from one or more spools into the feed hopper of the twin screw extruder, and then chopped into ¼ inch to 1 inch lengths by the twin screws to form a fiber reinforced polypropylene based composite articles.

It has surprisingly been found that substantially lubricant-free cloth-like fiber reinforced polypropylene compositions can be made which simultaneously have a flexural modulus of at least 300,000 psi and exhibit ductility during instrumented impact testing. More particularly, the cloth-like fiber reinforced polypropylene compositions surprisingly exhibit no decrease in impact properties upon the incorporation of colorant fiber needed to attain a cloth-like look. Still more particularly is the surprising ability to make such compositions using a wide range of polypropylenes as the matrix material, including some polypropylenes that without fiber are very brittle. The compositions of the present invention are particularly suitable for making articles including, but not limited to household appliances, automotive parts, and boat hulls. The cloth-like fiber reinforced polypropylene compositions may also be processed using an in-line compounding and molding process wherein the organic fiber is continuously unwound and fed into the extruder hopper of the twin screw extruder.

In one embodiment, the present invention provides an advantageous in-line compounding and molding process for making a fiber reinforced polypropylene part comprising the following steps: (a) providing an in-line compounding and molding machine comprising a twin screw extruder fluidly coupled to an injection molder; (b) extrusion compounding in the twin screw extruder a composition comprising at least 30 wt % polypropylene, from 10 to 60 wt % organic fiber, from 0 to 40 wt % inorganic filler, and from 0 to 0.1 wt % lubricant, based on the total weight of the composition, to form a melt extrudate; (c) conveying the melt extrudate to the injection molder; and (d) molding the melt extrudate in the injection molder to form a part having a flexural modulus of at least 300,000 psi and exhibiting ductility during instrumented impact testing.

In another embodiment, the present invention provides an advantageous in-line compounding and molding process for making a fiber reinforced polypropylene article comprising: (a) at least 30 wt %, based on the total weight of the composition, polypropylene; (b) from 10 to 60 wt %, based on the total weight of the composition, organic fiber; (c) from 0 to 40 wt %, based on the total weight of the composition, inorganic filler; and (d) from 0 to 0.1 wt %, based on the total weight of the composition, lubricant; wherein the composition has a flexural modulus of at least 400,000 psi, and exhibits ductility during instrumented impact testing, wherein the process comprises the following steps: (a) providing an in-line compounding and molding machine comprising a twin screw extruder fluidly coupled to an injection molder; (b) extrusion compounding the composition in the twin screw extruder to form a melt extrudate; (c) conveying the melt extrudate to the injection molder; and (d) molding the melt extrudate in the injection molder to form the article.

In yet another embodiment, the present invention provides an advantageous in-line compounding and molding process for making fiber reinforced polypropylene composite articles comprising the following steps: (a) providing an in-line compounding and molding machine comprising a twin screw extruder fluidly coupled to an injection molder, (b) feeding into the twin screw extruder hopper at least about 25 wt % of a polypropylene based resin with a melt flow rate of from about 20 to about 1500 g/10 minutes, (c) continuously feeding by unwinding from one or more spools into the twin screw extruder hopper from about 5 wt % to about 40 wt % of an organic fiber, (d) feeding into a twin screw extruder from about 10 wt % to about 60 wt % of an inorganic filler, (e) extruding the polypropylene based resin, the organic fiber, and the inorganic filler through the twin screw extruder to form a fiber reinforced polypropylene composite melt, (f) conveying the fiber reinforced polypropylene composite melt to the injection molder, and (g) molding the fiber reinforced polypropylene composite melt to form a fiber reinforced polypropylene composite article.

In yet another embodiment of the present disclosure provides an advantageous in-line compounding and molding process for making fiber reinforced polypropylene composite articles comprising: (a) at least 30 wt %, based on the total weight of the composition, polypropylene based polymer; (b) from 10 to 60 wt %, based on the total weight of the composition, organic reinforcing fiber; (c) from 0 to 40 wt %, based on the total weight of the composition, inorganic filler; and (d) from 0.1 to 2.5 wt %, based on the total weight of the composition, colorant fiber; wherein the article molded from the composition has a flexural modulus of at least 300,000 psi, exhibits ductility during instrumented impact testing, and exhibits a cloth-like appearance; wherein the process comprises the steps of: (a) providing an in-line compounding and molding machine comprising a twin screw extruder fluidly coupled to an injection molder; (b) extrusion compounding the composition in the twin screw extruder to form a melt extrudate; (c) conveying the melt extrudate to the injection molder; and (d) molding the melt extrudate in the injection molder to form the article.

In still yet another embodiment of the present disclosure provides an advantageous in-line compounding and molding process for making a fiber reinforced polypropylene resin composition comprising: (a) at least 25 wt %, based on the total weight of the composition, polypropylene based polymer with a melt flow rate of from about 20 to about 1500 g/10 minutes; (b) from 5 to 40 wt %, based on the total weight of the composition, organic reinforcing fiber; (c) from 10 to 60 wt %, based on the total weight of the composition, inorganic filler; and (d) from 0.1 to 2.5 wt %, based on the total weight of the composition, colorant fiber; wherein an article molded from the composition has a flexural modulus of at least about 300,000 psi, exhibits ductility during instrumented impact testing, and exhibits a cloth-like appearance; wherein the process comprises the steps of: (a) providing an in-line compounding and molding machine comprising a twin screw extruder fluidly coupled to an injection molder, (b) feeding into the twin screw extruder hopper the polypropylene based polymer, (c) continuously feeding by unwinding from one or more spools into the twin screw extruder hopper the organic reinforcing fiber; (d) extruding the polypropylene based resin, the organic reinforcing fiber, the inorganic filler, and the colorant fiber through the twin screw extruder to form a fiber reinforced polypropylene composite melt; (e) conveying the fiber reinforced polypropylene composite melt to the injection molder, and (f) molding the fiber reinforced polypropylene composite melt to form a fiber reinforced polypropylene composite article.

Numerous advantages result from the advantageous in-line compounding and molding process for making fiber reinforced polypropylene composites disclosed herein and the uses/applications therefore.

For example, in exemplary embodiments of the present disclosure, the disclosed polypropylene fiber composites exhibit improved instrumented impact resistance.

In a further exemplary embodiment of the present disclosure, the disclosed polypropylene fiber composites exhibit improved flexural modulus.

In a further exemplary embodiment of the present disclosure, the disclosed polypropylene fiber composites do not splinter or shatter during instrumented impact testing.

In yet a further exemplary embodiment of the present disclosure, the disclosed polypropylene fiber composites exhibit fiber pull out during instrumented impact testing without the need for lubricant additives.

In yet a further exemplary embodiment of the present disclosure, the disclosed polypropylene fiber composites exhibit a higher heat distortion temperature compared to rubber toughened polypropylene.

In yet a further exemplary embodiment of the present disclosure, the disclosed polypropylene fiber composites exhibit a lower flow and cross flow coefficient of linear thermal expansion compared to rubber toughened polypropylene.

In yet another exemplary embodiment of the present disclosure, the disclosed in-line compounding and molding process for making polypropylene fiber composites exhibits the ability to continuously and accurately feed organic reinforcing fiber into a twin screw compounding extruder.

In another exemplary embodiment of the present disclosure, the disclosed in-line compounding and molding process for making polypropylene fiber composites exhibits reduced production costs and reduced raw material costs.

In another exemplary embodiment of the present disclosure, the disclosed in-line compounding and molding process for making polypropylene fiber composites exhibits higher material quality.

In yet a further exemplary embodiment of the present disclosure, the disclosed in-line compounding and molding process for making polypropylene fiber composites exhibits shorter molding cycle times.

In yet a further exemplary embodiment of the present disclosure, the disclosed in-line compounding and molding process for making polypropylene fiber composites exhibits improved flexibility in part formulations.

In yet a further exemplary embodiment of the present disclosure, the disclosed in-line compounding and molding process for making polypropylene fiber composites exhibits improved retention of fiber properties after processing.

In yet a further exemplary embodiment of the present disclosure, the disclosed in-line compounding and molding process for making polypropylene fiber composites exhibits improvements in melt temperature control which provides for reduced clamping forces during molding.

In yet a further exemplary embodiment of the present disclosure, the disclosed in-line compounding and molding process for making polypropylene fiber composites exhibits a cloth-like look and feel.

In yet a further exemplary embodiment of the present disclosure, the disclosed in-line compounding and molding process for making polypropylene fiber composites retain their impact resistance, ductile failure mode and stiffness after the incorporation of colorant with colored fiber.

In yet a further exemplary embodiment of the present disclosure, the disclosed in-line compounding and molding process for making polypropylene fiber composites is suitable for making automotive parts.

These and other advantages, features and attributes of the disclosed in-line compounding and molding process for making polypropylene fiber composites and their advantageous applications and/or uses will be apparent from the detailed description which follows, particularly when read in conjunction with the figures appended hereto.

### BRIEF DESCRIPTION OF THE DRAWINGS

To assist those of ordinary skill in the relevant art in making and using the subject matter hereof, reference is made to the appended drawings, wherein:

FIG. 1 depicts an exemplary schematic of the in-line compounding and molding process with an intermediate melt reservoir for making fiber reinforced polypropylene composites of the instant invention.

FIG. 2 depicts an exemplary schematic of the upstream twin screw extruder used as part of the in-line compounding and molding process for making fiber reinforced polypropylene composites of the instant invention.

FIG. 3 depicts an exemplary schematic of a twin screw extruder screw configuration of the in-line compounding and molding process for making fiber reinforced polypropylene composites of the instant invention.

FIG. 4 depicts an alternative exemplary schematic of the in-line compounding and molding process without an intermediate melt reservoir for making fiber reinforced polypropylene composites of the instant invention.

FIG. 5 depicts an exemplary schematic of the in-line compounding and molding process with an intermediate melt reservoir for making cloth-like fiber reinforced polypropylene composites of the instant invention.

FIG. 6 depicts an alternative exemplary schematic of the in-line compounding and molding process without an intermediate melt reservoir for making the cloth-like fiber reinforced polypropylene composites of the instant invention.

### DETAILED DESCRIPTION OF THE INVENTION

The present invention relates to an improved in-line compounding and molding process for making fiber reinforced polypropylene compositions and also cloth-like fiber reinforced polypropylene compositions. The in-line compounding and molding process for making fiber reinforced polypropylene compositions is distinguishable over the prior art in comprising in one process the compounding and molding of a polypropylene based matrix with organic reinforcing fiber and inorganic filler, which in combination advantageously yields articles molded from the compositions with a flexural modulus of at least 300,000 psi and ductility during instrumented impact testing (15 mph, −29° C., 25 lbs). The in-line compounding and molding process for making fiber reinforced polypropylene compositions of the present invention is also distinguishable over the prior art in comprising a polypropylene based matrix polymer with an advantageous high melt flow rate without sacrificing impact resistance. In addition, fiber reinforced polypropylene compositions of the present invention do not splinter or shatter during instrumented impact testing.

The present invention also relates to an improved in-line compounding and molding process for making cloth-like fiber reinforced polypropylene compositions, which are distinguishable over the prior art in providing a combination of outstanding stiffness, impact resistance, and splinter resistance upon impact failure. Unlike the prior art cloth-like compositions, the cloth-like fiber reinforced polypropylene compositions of the present invention retain their impact properties upon the addition of additives required for imparting a cloth-like look.

The in-line compounding and molding process for making fiber reinforced polypropylene compositions of the present invention combines the beneficial aspects of the compounding of polypropylene resin, organic fiber and inorganic filler through a compounding process with the beneficial aspects of molding the compounded melt to form a fiber reinforced polypropylene melt. Exemplary, but not limiting, compounding processes include twin screw extrusion, and single screw extrusion. Twin screw extrusion is preferred because of its ability to more effectively disperse high additive loadings into a polymeric melt. Exemplary, but not limiting, molding processes include injection molding, blow molding, rotational molding, thermoforming, compression molding, and compression/injection molding. Injection molding is preferred because of its ability to produce a wide range of plastic parts and articles. U.S. patent application Nos. 6,071,462 and 6,854,968 are directed to combined compounder-type injection molding machines and are both herein incorporated by reference in their entirety.

The fiber reinforced polypropylene compositions of the present invention simultaneously have desirable stiffness, as measured by having a flexural modulus of at least 300,000 psi, and toughness, as measured by exhibiting ductility during instrumented impact testing. In a particular embodiment, the compositions have a flexural modulus of at least 350,000 psi, or at least 370,000 psi, or at least 390,000 psi, or at least 400,000 psi, or at least 450,000 psi. Still more particularly, the compositions have a flexural modulus of at least 600,000 psi, or at least 800,000 psi. It is also believed that having a weak interface between the polypropylene matrix and the fiber contributes to fiber pullout; and, therefore, may enhance toughness. Thus, there is no need to add modified polypropylenes to enhance bonding between the organic reinforcing fiber and the polypropylene matrix, although the use of modified polypropylene may be advantageous to enhance the bonding between a filler such as talc or wollastonite and the matrix. In addition, in one embodiment, there is no need to add lubricant to weaken the interface between the polypropylene and the organic reinforcing fiber to further enhance fiber pullout. Some embodiments also display no splintering during instrumented dart impact testing, which yield a further advantage of not subjecting a person in close proximity to the impact to potentially harmful splintered fragments.

Compositions of the present invention generally include at least 30 wt %, based on the total weight of the composition, of polypropylene as the matrix resin. In a particular embodiment, the polypropylene is present in an amount of at least 30 wt %, or at least 35 wt %, or at least 40 wt %, or at least 45 wt %, or at least 50 wt %, or in an amount within the range having a lower limit of 30 wt %, or 35 wt %, or 40 wt %, or 45 wt %, or 50 wt %, and an upper limit of 75 wt %, or 80 wt %, based on the total weight of the composition. In another embodiment, the polypropylene is present in an amount of at least 25 wt %.

The polypropylene used as the matrix resin is not particularly restricted and is generally selected from the group consisting of propylene homopolymers, propylene-ethylene random copolymers, propylene-α-olefin random copolymers, propylene block copolymers, propylene impact copolymers, and combinations thereof. In a particular embodiment, the polypropylene is a propylene homopolymer. In another particular embodiment, the polypropylene is a propylene impact copolymer comprising from 78 to 95 wt % homopolypropylene and from 5 to 22 wt % ethylene-propylene rubber, based on the total weight of the impact copolymer. In a particular aspect of this embodiment, the propylene impact copolymer comprises from 90 to 95 wt % homopolypropylene and from 5 to 10 wt % ethylene-propylene rubber, based on the total weight of the impact copolymer.

The polypropylene of the matrix resin may have a melt flow rate of from about 20 to about 1500 g/10 min. In a particular embodiment, the melt flow rate of the polypropylene matrix resin is greater than 100 g/10 min, and still more particularly greater than or equal to 400 g/10 min. In yet another embodiment, the melt flow rate of the polypropylene matrix resin is about 1500 g/10 min. The higher melt flow rate permits for improvements in processability, throughput rates, and higher loading levels of organic reinforcing fiber and inorganic filler without negatively impacting flexural modulus and impact resistance.

In a particular embodiment, the matrix polypropylene contains less than 0.1 wt % of a modifier, based on the total weight of the polypropylene. Typical modifiers include, for example, unsaturated carboxylic acids, such as acrylic acid, methacrylic acid, maleic acid, itaconic acid, fumaric acid or esters thereof, maleic anhydride, itaconic anhydride, and derivates thereof. In another particular embodiment, the matrix polypropylene does not contain a modifier. In still yet another particular embodiment, the polypropylene based polymer further includes from about 0.1 wt % to less than about 10 wt % of a polypropylene based polymer modified with a grafting agent. The grafting agent includes, but is not limited to, acrylic acid, methacrylic acid, maleic acid, itaconic acid, fumaric acid or esters thereof, maleic anhydride, itaconic anhydride, and combinations thereof.

The polypropylene may further contain additives commonly known in the art, such as dispersant, lubricant; flame-retardant, antioxidant, antistatic agent, light stabilizer, ultraviolet light absorber, carbon black, nucleating agent, plasticizer, and coloring agent such as dye or pigment. The amount of additive, if present, in the polypropylene matrix is generally from 0.5 wt %, or 2.5 wt %, to 7.5 wt %, or 10 wt %, based on the total weight of the matrix. Diffusion of additive(s) during processing may cause a portion of the additive(s) to be present in the organic reinforcing fiber.

The invention is not limited by any particular polymerization method for producing the matrix polypropylene, and the polymerization processes described herein are not limited by any particular type of reaction vessel. For example, the matrix polypropylene can be produced using any of the well known processes of solution polymerization, slurry polymerization, bulk polymerization, gas phase polymerization, and combinations thereof. Furthermore, the invention is not limited to any particular catalyst for making the polypropylene, and may, for example, include Ziegler-Natta or metallocene catalysts.

Compositions of the present invention generally include at least 10 wt %, based on the total weight of the composition, of an organic reinforcing fiber. In a particular embodiment, the fiber is present in an amount of at least 10 wt %, or at least 15 wt %, or at least 20 wt %, or in an amount within the range having a lower limit of 10 wt %, or 15 wt %, or 20 wt %, and an upper limit of 50 wt %, or 55 wt %, or 60 wt %, or 70 wt %, based on the total weight of the composition. In another embodiment, the organic reinforcing fiber is present in an amount of at least 5 wt % and up to 40 wt %.

The polymer used as the reinforcing fiber is not particularly restricted and is generally selected from the group consisting of polyalkylene terephthalates, polyalkylene naphthalates, polyamides, polyolefins, polyacrylonitrile, and combinations thereof. In a particular embodiment, the fiber comprises a polymer selected from the group consisting of polyethylene terephthalate (PET), polybutylene terephthalate, polyamide and acrylic. In another particular embodiment, the organic reinforcing fiber comprises PET.

In one embodiment, the organic reinforcing fiber is a single component fiber. In another embodiment, the organic reinforcing fiber is a multicomponent fiber wherein the fiber is formed from a process wherein at least two polymers are extruded from separate extruders and meltblown or spun together to form one fiber. In a particular aspect of this embodiment, the polymers used in the multicomponent reinforcing fiber are substantially the same. In another particular aspect of this embodiment, the polymers used in the multicomponent reinforcing fiber are different from each other. The configuration of the multicomponent reinforcing fiber can be, for example, a sheath/core arrangement, a side-by-side arrangement, a pie arrangement, an islands-in-the-sea arrangement, or a variation thereof. The reinforcing fiber may also be drawn to enhance mechanical properties via orientation, and subsequently annealed at elevated temperatures, but below the crystalline melting point to reduce shrinkage and improve dimensional stability at elevated temperature.

The length and diameter of the reinforcing fibers of the present invention are not particularly restricted. In a particular embodiment, the fibers have a length of ¼ inch, or a length within the range having a lower limit of ⅛ inch, or ⅙ inch, and an upper limit of ⅓ inch, or ½ inch. In another particular embodiment, the diameter of the reinforcing fibers is within the range having a lower limit of 10 μm and an upper limit of 100 μm.

The reinforcing fiber may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment.

The reinforcing fiber used to make the compositions of the present invention is not limited by any particular fiber form. For example, the fiber can be in the form of continuous filament yarn, partially oriented yarn, or staple fiber. In another embodiment, the fiber may be a continuous multifilament fiber or a continuous monofilament fiber.

In another exemplary embodiment of the present invention, the fiber reinforced polypropylene composition may be made cloth-like in terms of appearance, feel, or a combination thereof. Cloth-like appearance or look is defined as having a uniform short fiber type of surface appearance. Cloth-like feel is defined as having a textured surface or fabric type feel. The incorporation of the colorant fiber into the fiber reinforced polypropylene composition results in a cloth-like appearance. When the fiber reinforced polypropylene composition is processed through a mold with a textured surface, a cloth-like feel is also imparted to the surface of the resulting molded part.

Cloth-like fiber reinforced polypropylene compositions of the present invention generally include from about 0.1 to about 2.5 wt %, based on the total weight of the composition, of a colorant fiber. Still more preferably, the colorant fiber is present from about 0.5 to about 1.5 wt %, based on the total weight of the composition. Even still more preferably, the colorant fiber is present at less than about 1.0 wt %, based on the total weight of the composition.

The colorant fiber type is not particularly restricted and is generally selected from the group consisting of cellulosic fiber, acrylic fiber, nylon fiber or polyester type fiber. Polyester type fibers include, but are not limited to, polyethylene terephlalate, polybutylene terephalate, and polyethylene naphthalate. Polyamide type fibers include, but are not limited to, nylon 6, nylon 6,6, nylon 4,6 and nylon 6,12. In a particular embodiment, the colorant fiber is cellulosic fiber, also commonly referred to as rayon. In another particular embodiment, the colorant fiber is a nylon type fiber.

The colorant fiber used to make the compositions of the present invention is not limited by any particular fiber form prior to being chopped for incorporation into the fiber reinforced polypropylene composition. For example, the colorant fiber can be in the form of continuous filament yarn, partially oriented yarn, or staple fiber. In another embodiment, the colorant fiber may be a continuous multifilament fiber or a continuous monofilament fiber.

The length and diameter of the colorant fiber may be varied to alter the cloth-like appearance in the molded article. The length and diameter of the colorant fiber of the present invention is not particularly restricted. In a particular embodiment, the fibers have a length of less than about ¼ inch, or preferably a length of between about 1/32 to about ⅛ inch. In another particular embodiment, the diameter of the colorant fibers is within the range having a lower limit of about 10 μm and an upper limit of about 100 μm.

The colorant fiber is colored with a coloring agent, which comprises either inorganic pigments, organic dyes or a combination thereof. U.S. Pat. Nos. 5,894,048; 4,894,264; 4,536,184; 5,683,805; 5,328,743; and 4,681,803 disclose the use of coloring agents, the disclosures of which are incorporated herein by reference in their entirety. Exemplary pigments and dyes incorporated into the colorant fiber include, but are not limited to, phthalocyanine, azo, condensed azo, azo lake, anthraquinone, perylene/perinone, indigo/thioindigo, isoindolinone, azomethineazo, dioxazine, quinacridone, aniline black, triphenylmethane, carbon black, titanium oxide, iron oxide, iron hydroxide, chrome oxide, spinel-form calcination type, chromic acid, talc, chrome vermilion, iron blue, aluminum powder and bronze powder pigments. These pigments may be provided in any form or may be subjected in advance to various dispersion treatments in a manner known per se in the art. Depending on the material to be colored, the coloring agent can be added with one or more of various additives such as organic solvents, resins, flame retardants, antioxidants, ultraviolet absorbers, plasticizers and surfactants.

The base fiber reinforced polypropylene composite material that the colorant fiber is incorporated into may also be colored using the inorganic pigments, organic dyes or combinations thereof. Exemplary pigments and dyes for the base fiber reinforced polypropylene composite material may be of the same types as indicated in the preceding paragraph for the colorant fiber. Typically the base fiber reinforced polypropylene composite material is made of a different color or a different shade of color than the colorant fiber, such as to create a cloth-like appearance upon uniformly dispersing the short colorant fibers in the colored base fiber reinforced polypropylene composite material. In one particular exemplary embodiment, the base fiber reinforced polypropylene composite material is light grey in color and the colorant fiber is dark grey or blue in color to create a cloth-like look from the addition of the short colorant fiber uniformly dispersed through the base fiber reinforced polypropylene composite material.

The colorant fiber in the form of chopped fiber may be incorporated directly into the base fiber reinforced polypropylene composite material via the twin screw extrusion compounding process, or may be incorporated as part of a masterbatch resin to further facilitate the dispersion of the coloraht fiber within the fiber reinforced polypropylene composite base material. When the colorant fiber is incorporated as part of a masterbatch resins, exemplary carrier resins include, but are not limited to, polypropylene homopolymer, ethylene-propylene copolymer, ethylene-propylene-butene-1 terpolymer, propylene-butene-1 copolymer, low density polyethylene, high density polyethylene, and linear low density polyethylene. In one exemplary embodiment, the colorant fiber is incorporated into the carrier resin at less than about 25 wt %. The colorant fiber masterbatch is then incorporated into the fiber reinforced polypropylene composite base material at a loading of from about 1 wt % to about 10 wt %, and preferably from about 2 to about 6 wt %. In a particularly preferred embodiment, the colorant fiber masterbatch is added at about 4 wt % based on the total weight of the composition. In another exemplary embodiment, a masterbatch of either black rayon or black nylon type fibers in linear low density polyethylene carrier resin is incorporated at a loading of about 4 wt % in the fiber reinforced polypropylene composite base material.

The colorant fiber or colorant fiber masterbatch may be fed to the twin screw extrusion compounding process with a gravimetric feeder at either the feed hopper or at a downstream feed port in the barrel of the twin screw extruder. Kneading and mixing elements are incorporated into the twin screw extruder screw design downstream of the colorant fiber or colorant fiber masterbatch injection point, such as to uniformly disperse the colorant fiber within the cloth-like fiber reinforced polypropylene composite material.

Compositions of the present invention optionally include inorganic filler in an amount of at least 1 wt %, or at least 5 wt %, or at least 10 wt %, or in an amount within the range having a lower limit of 0 wt %, or 1 wt %, or 5 wt %, or 10 wt %, or 15 wt %, and an upper limit of 25 wt %, or 30 wt %, or 35 wt %, or 40 wt %, based on the total weight of the composition. In yet another embodiment, the inorganic filler may be included in the polypropylene fiber composite in the range of from 10 wt % to about 60 wt %. In a particular embodiment, the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof. The talc may have a size of from about 1 to about 100 microns. In one particular embodiment, at a high talc loading of up to about 60 wt %, the polypropylene fiber composite exhibited a flexural modulus of at least about 750,000 psi and no splintering during instrumented impact testing (15 mph, −29° C., 25 lbs). In another particular embodiment, at a low talc loading of as low as 10 wt %, the polypropylene fiber composite exhibited a flexural modulus of at least about 325,000 psi and no splintering during instrumented impact testing (15 mph, −29° C., 25 lbs). In addition, wollastonite loadings of from 10 wt % to 60 wt % in the polypropylene fiber composite yielded an outstanding combination of impact resistance and stiffness.

In another particular embodiment, a fiber reinforced polypropylene composition including a polypropylene based resin with a melt flow rate of 80 to 1500, 10 to 15 wt % of polyester fiber, and 50 to 60 wt % of inorganic filler displayed a flexural modulus of 850,000 to 1,200,000 psi and did not shatter during instrumented impact testing at −29 degrees centigrade, tested at 25 pounds and 15 miles per hour. The inorganic filler includes, but is not limited to, talc and wollastonite. This combination of stiffness and toughness is difficult to achieve in a polymeric based material. In addition, the fiber reinforced polypropylene composition has a heat distortion temperature at 66 psi of 140 degrees centigrade, and a flow and cross flow coefficient of linear thermal expansion of 2.2×10⁻⁵ and 3.3×10⁻⁵ per degree centigrade respectively. In comparison, rubber toughened polypropylene has a heat distortion temperature of 94.6 degrees centigrade, and a flow and cross flow thermal expansion coefficient of 10×10⁻⁵ and 18.6×10⁻⁵ per degree centigrade respectively.

The fiber reinforced polypropylene compositions of the present invention yield an advantageous combination of toughness, stiffness, and aesthetics. In particular, instrumented impact of molded articles is not negatively affected by the incorporation of the colorant fiber. In addition, the failure mode during instrumented impact testing is ductile (non-splintering) as opposed to brittle (splintering).

Articles made from the compositions described herein include, but are not limited to automotive parts, household appliances, and boat hulls. Cloth-like articles are particularly suitable for interior automotive parts because of the unique combination of toughness, stiffness and aesthetics. More particularly, the non-splintering nature of the failure mode during instrumented impact testing, and the cloth-like look make the cloth-like reinforced polypropylene composites of the present invention particularly suited for interior automotive parts, even more particularly suited for interior trim cover panels. Exemplary, but not limiting, interior trim cover panels include steering wheel covers, head liner panels, dashboard panels, interior door trim panels, pillar trim cover panels, and under-dashboard panels. Pillar trim cover panels include a front pillar trim cover panel, a center pillar trim cover panel, and a quarter pillar trim cover panel. Other interior automotive parts include package trays, and seat backs. Articles made from the compositions described herein are also suitable for exterior automotive parts, including, but not limited to, bumpers, aesthetic trim parts, body panels, under body parts, under hood parts, door cores, and other structural parts of the automobile.

Articles of the present invention are made by directly forming the polypropylene resin and additives needed to form fiber-reinforced polypropylene composition into an article or part via a combined in-line compounding and molding process. To achieve a cloth-like surface feel in the article, the mold surface may also have a textured surface. The invention is not limited by any particular method for forming the compositions. For example, the compositions can be formed by contacting polypropylene, organic reinforcing fiber, colorant fiber, and optional inorganic filler in any of the well known processes of pultrusion or extrusion compounding. In a particular embodiment, the compositions are formed in an extrusion compounding process. In a particular aspect of this embodiment, the organic reinforcing fibers are cut prior to being placed in the extruder hopper. In another particular aspect of this embodiment, the organic reinforcing fibers are fed directly from one or more spools into the extruder hopper.

In another particular embodiment, the compounding and molding steps are combined into one process referred to as an in-line compounding and molding process that consists of the coupling of a compounding process and a molding process. This eliminates the need of a molder having to stock various % levels of PET fiber in polypropylene and from buying several different kinds of PP/PET with the correct fiber levels needed. It also eliminates issues with storage, cost, and heat history associated with separate compounding and molding processes. In particular, if a molder would need various % levels of PET fiber in polypropylene, they would need to buy several different kinds of PP/PET with the correct fiber levels. This would take up a lot of storage space. Another beneficial aspect of the pre-compounding of the PP and PET fiber is a reduction in the cost of the final product. Compounding costs of between $0.06 to $0.50 per pound may be eliminated with the in-line compounding and molding process of the present invention.

Another benefit of the in-line compounding and molding process for making fiber reinforced PP compositions of the present invention is that the number of heat histories of the material is reduced, which in turn improves the physical properties of the finished product. PET fiber is heat set at approximately 420 deg. F. Each time the polymer is melted in the presence of the fiber, there is some possibility of the fiber losing its mechanical integrity. If the fiber is heated above the heat set temperature at which the fiber is formed, it loses the impact improvement properties the PET fiber adds to the polypropylene. Using in-line compounding, materials comprising reinforced polypropylene compositions may be compounded and molded all in one step. The polymer, fiber and talc filler may be introduced into an extruder attached directly to an injection or compression molder. Instead of creating pellets of compounded material in a separate compounding process, which are later molded, the molten compound is conveyed directly to the mold from the compounding process. In one exemplary embodiment of the in-line compounding and molding process of the present invention, between the compounding process and the molding process may be a melt reservoir for holding surge melt from the continuous compounding process before it enters into the discontinuous molding process. In another exemplary embodiment of the in-line compounding and molding process of the present invention, between the compounding process and the molding process is a flow channel without a melt reservoir that leads to two or more molding units.

In another exemplary embodiment, an in-line compounding and molding machine may blend in the organic fiber into the polypropylene melt stream. The machine has a special extruded/plunger system that can melt the polypropylene resin, feed in the organic fiber, and any other reinforcement or additives needed in the product. The plunger or injection unit then acts as a standard injection molding machine that injects the material into the mold. Fibers may be fed into the extruder from spools or from a feeder that feeds chopped fibers of the desired length. This permits the molder to put in as much or little fiber as desired. Also the PET fiber is only subjected to one heat history reducing the likelihood of negatively impacting the fiber properties.

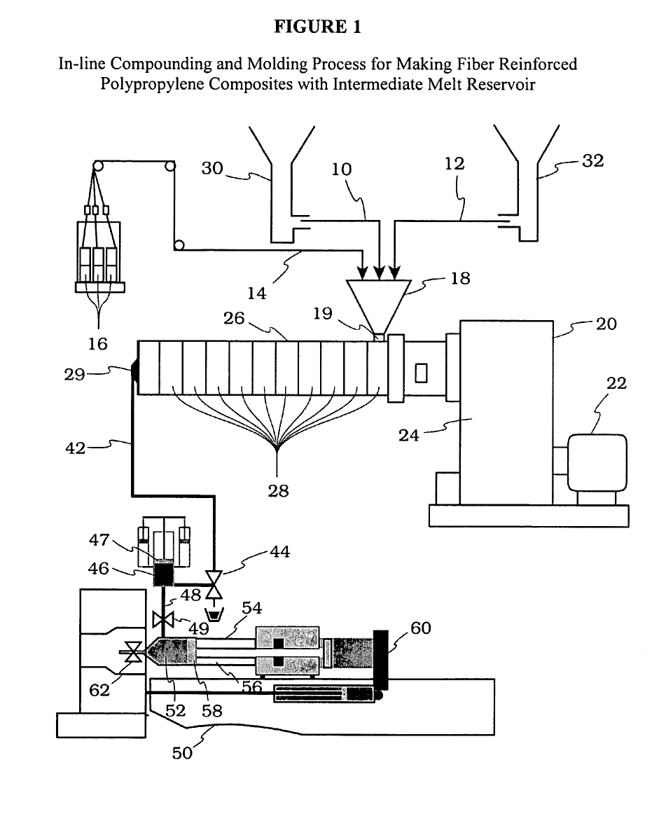

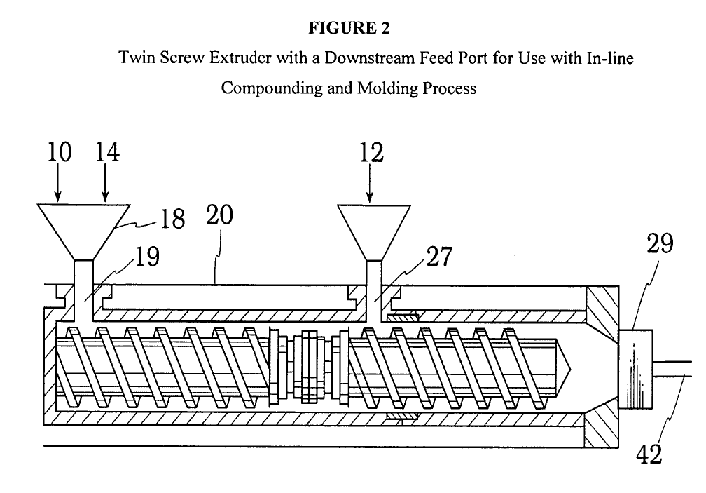

FIG. 1 depicts an exemplary schematic of the in-line process for making fiber reinforced polypropylene composites of the instant invention. Polypropylene based resin 10, inorganic filler 12, and organic fiber 14 continuously unwound from one or more spools 16 are fed into an extruder hopper 18 of a twin screw compounding extruder 20. The extruder hopper 18 is positioned above the feed throat 19 of the twin screw compounding extruder 20. The extruder hopper 18 may alternatively be provided with an auger (not shown) for mixing the polypropylene based resin 10 and the inorganic filler 12 prior to entering the feed throat 19 of the twin screw compounding extruder 20. In an alternative embodiment, as depicted in FIG. 2, the inorganic filler 12 may be fed to the twin screw compounding extruder 20 at a downstream feed port 27 in the extruder barrel 26 positioned downstream of the extruder hopper 18 while the polypropylene based resin 10 and the organic fiber 14 are still metered into the extruder hopper 18.

The polypropylene based resin 10 is metered to the extruder hopper 18 via a feed system 30 for accurately controlling the feed rate. Similarly, the inorganic filler 12 is metered to the extruder hopper 18 via a feed system 32 for accurately controlling the feed rate. The feed systems 30, 32 may be, but are not limited to, gravimetric feed system or volumetric feed systems. Gravimetric feed systems are particularly preferred for accurately controlling the weight percentage of polypropylene based resin 10 and inorganic filler 12 being fed to the extruder hopper 18. The feed rate of organic fiber 14 to the extruder hopper 18 is controlled by a combination of the extruder screw speed, number of fiber filaments and the thickness of each filament in a given fiber spool, and the number of fiber spools 16 being unwound simultaneously to the extruder hopper 18. The higher the extruder screw speed measured in revolutions per minute (rpms), the greater will be the rate at which organic fiber 14 is fed to the twin screw compounding screw 20. The rate at which organic fiber 14 is fed to the extruder hopper also increases with the greater the number of filaments within the organic fiber 14 being unwound from a single fiber spool 16, the greater filament thickness, the greater the number fiber spools 16 being unwound simultaneously, and the rotations per minute of the extruder.

The twin screw compounding extruder 20 includes a drive motor 22, a gear box 24, and an extruder barrel 26 for holding two screws (not shown). The extruder barrel 26 is segmented into a number of heated temperature controlled zones 28. As depicted in FIG. 1, the extruder barrel 26 includes a total of ten temperature control zones 28. The two screws within the extruder barrel 26 of the twin screw compounding extruder 20 may be intermeshing or non-intermeshing, and may rotate in the same direction (co-rotating) or rotate in opposite directions (counter-rotating). From a processing perspective, the melt temperature must be maintained above that of the polypropylene based resin 10, and far below the melting temperature of the organic fiber 14, such that the mechanical properties imparted by the organic fiber will be maintained when mixed into the polypropylene based resin 10. In one exemplary embodiment, the barrel temperature of the extruder zones did not exceed 154° C. when extruding PP homopolymer and PET fiber, which yielded a melt temperature above the melting point of the PP homopolymer, but far below the melting point of the PET fiber. In another exemplary embodiment, the barrel temperatures of the extruder zones are set at 185° C. or lower. In yet another exemplary embodiment, the barrel temperatures of the extruder zones are set at 210° C. or lower.

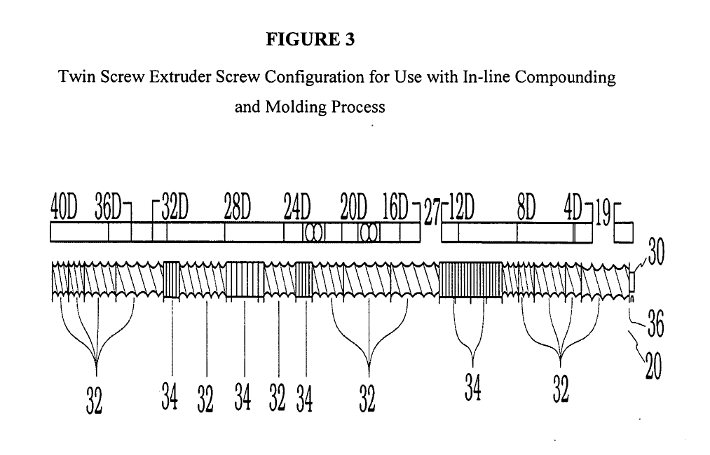

An exemplary schematic of a twin screw compounding extruder 20 screw configuration for making fiber reinforced polypropylene composites is depicted in FIG. 3. The feed throat 19 allows for the introduction of polypropylene based resin, organic fiber, and inorganic filler into a feed zone of the twin screw compounding extruder 20. The inorganic filler may be optionally fed to the extruder 20 at the downstream feed port 27. The twin screws 30 include an arrangement of interconnected screw sections, including conveying elements 32 and kneading elements 34. The kneading elements 34 function to melt the polypropylene based resin, cut the organic fiber lengthwise, and mix the polypropylene based melt, chopped organic fiber and inorganic filler to form a uniform blend. More particularly, the kneading elements function to break up the organic fiber into about ⅛ inch to about 1 inch fiber lengths. A series of interconnected kneading elements 34 is also referred to as a kneading block. U.S. Pat. No. 4,824,256 to Haring, et al., herein incorporated by reference in its entirety, discloses co-rotating twin screw extruders with kneading elements. The first section of kneading elements 34 located downstream from the feed throat is also referred to as the melting zone of the twin screw compounding extruder 20. The conveying elements 32 function to convey the solid components, melt the polypropylene based resin, and convey the melt mixture of polypropylene based polymer, inorganic filler and organic fiber downstream toward the discharge end of the extruder 29 (see FIG. 2) at a positive pressure.

The position of each of the screw sections as expressed in the number of diameters (D) from the start 36 of the extruder screws 30 is also depicted in FIG. 3. The extruder screws in FIG. 3 have a length to diameter ratio of 40/1, and at a position 32D from the start 36 of screws 30, there is positioned a kneading element 34. The particular arrangement of kneading and conveying sections is not limited to that as depicted in FIG. 3, however one or more kneading blocks consisting of an arrangement of interconnected kneading elements 34 may be positioned in the twin screws 30 at a point downstream of where organic fiber and inorganic filler are introduced to the extruder barrel. The twin screws 30 may be of equal screw length or unequal screw length. Other types of mixing sections may also be included in the twin screws 30, including, but not limited to, Maddock mixers, and pin mixers.

Referring once again to FIG. 1, the uniformly mixed fiber reinforced polypropylene composite melt comprising polypropylene based polymer 10, inorganic filler 12, and organic fiber 14 is metered by the extruder screws (not shown) to the discharge end of the extruder 29 to which is coupled or connected to a heated and temperature controlled melt pipe 42 which leads to a shut-off/purge valve 44. The fiber reinforced polypropylene composite melt then leads to an intermediate melt reservoir 46 for temporary storage prior to being conveyed to another heated and temperature controlled melt pipe 48 that leads to the molding unit 50. Within the intermediate melt reservoir 46 is a plunger 47, which is moved back and forth to expand the volume in the reservoir 46 to convey the melt to the molding unit 50. The plunger 47 within the intermediate melt reservoir 46 regulates flow of melt between the reservoir 46 and a melt chamber 52 of the injection device 54. Between the intermediate melt reservoir 46 and the melt chamber 52 of the injection device 54 is a shut-off valve 49 positioned within the second heated and temperature controlled melt pipe 42. The injection device 54 includes an injection cylinder 56 and an injection ram 58 reciprocating in the injection cylinder 56, whereby the melt chamber 52 is provided in the forward portion of the injection cylinder 56, anteriorly of the injection ram 58. Reciprocation of the injection ram 58 is implemented by a drive mechanism, generally designated by reference numeral 60 so that the ram 58 can be actively pushed forward or pulled backwards. The drive mechanism 60 may be realized in the form of an electric, pneumatic, or a hydraulic system.

The in-line compounding and molding process operates in the following manner. The screws of the twin screw extruder 20 are continuously driven by the drive motor 22, whereby the polypropylene resin 10, organic fiber 14, and inorganic filler 12 are continuously fed to the extruder hopper 18 as described above. The twin screw extruder 20 mixes the starting materials to produce a melt which is discharged through outlet 29 in the form of a continuous stream which is directed through conduits or melt pipes 42, 48 to the injection device 50. The injection device 50 operates essentially in two cycles, namely a filling phase and an injection phase. In the injection phase, the shutoff valve 49 is closed to prevent melt pressure building up in the injection device 50 from acting in the direction of the intermediate melt reservoir 46, and to allow injection of melt into an injection mold (not shown) via a shutoff valve 62, which is open. After conclusion of the injection phase, shutoff valve 62 is closed and shutoff valve 49 is opened to initiate the filling phase in which the injection ram 58 moves backwards as the melt chamber 52 of the injection device 60 is filled again via conduit or melt pipe 48 with melt. Melt produced by the twin screw extruder 20 is temporarily stored in the melt reservoir 46 during the injection procedure, whereby the plunger 47 is hereby moved back to expand the volume in the melt reservoir 46.

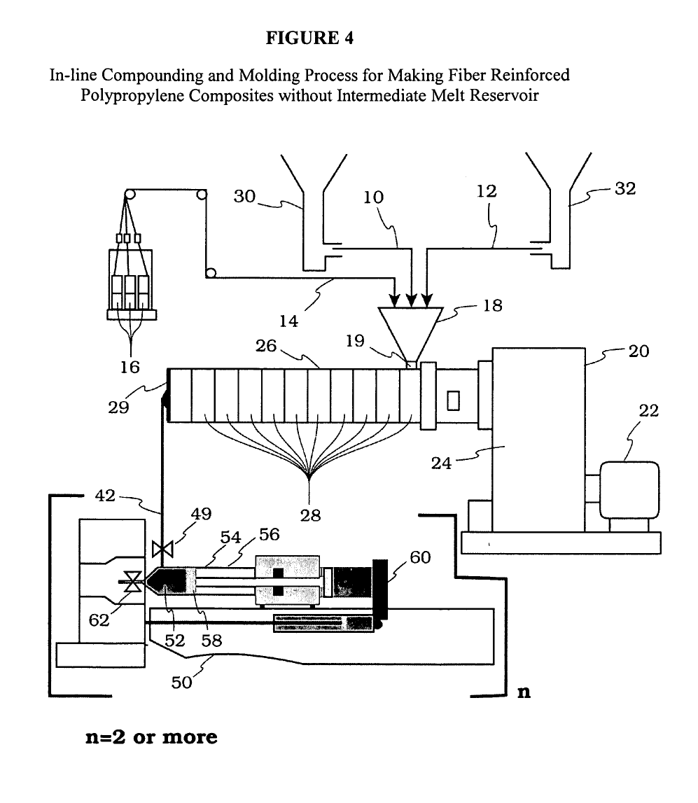

FIG. 4 depicts an alternative exemplary schematic of the in-line process for making fiber reinforced polypropylene composites of the instant invention. The process of FIG. 4 is similar to FIG. 1, except for the hardware between the twin screw extruder 20 and the injection device 50. Parts corresponding with those in FIG. 1 are denoted by identical reference numerals and may not be explained again. Polypropylene based resin 10, inorganic filler 12, and organic fiber 14 continuously unwound from one or more spools 16 are fed into an extruder hopper 18 of a twin screw compounding extruder 20. The extruder hopper 18 is positioned above the feed throat 19 of the twin screw compounding extruder 20. The extruder hopper 18 may alternatively be provided with an auger (not shown) for mixing the polypropylene based resin 10 and the inorganic filler 12 prior to entering the feed throat 19 of the twin screw compounding extruder 20. In an alternative embodiment, as depicted in FIG. 2, the inorganic filler 12 may be fed to the twin screw compounding extruder 20 at a downstream feed port 27 in the extruder barrel 26 positioned downstream of the extruder hopper 18 while the polypropylene based resin 10 and the organic fiber 14 are still metered into the extruder hopper 18.

The in-line compounding and molding machine of FIG. 4 includes a twin screw extruder 20 which is directly connected to the molding unit 50, without provision of an intermediate melt reservoir. The twin screw extruder 20 is coupled to the molding unit 50 via a heated and temperature controlled melt pipe 42. Also within the melt pipe 42 is a shutoff valve 49 for stopping melt flow between the twin screw extruder 20 and the melt reservoir 52 of the injection device 54. The injection device 54 again operates essentially in two cycles, namely a filling phase and an injection phase. When the molding machine 50 is in the filling phase and valve 49 in melt pipe 42 is open, a control unit (not shown), in response to a pressure deviation, instructs a control valve (not shown) to activate the drive mechanism 60 to move the injection ram 58 back to expand the volume of the melt chamber 52. As a consequence, the actual melt pressure is adjusted to the desired level. When the injection device 54 is in the injection phase, the shutoff valve 49 is closed to prevent melt pressure building up in the injection device 50 from acting in the direction of the twin screw extruder 20, and to allow injection of melt into an injection mold (not shown) via a shutoff valve 62, which is open. After conclusion of the injection phase, shutoff valve 62 is closed and shutoff valve 49 is opened to initiate the filling phase in which the injection ram 58 moves backwards as the melt chamber 52 of the injection device 54 is filled again via conduit or melt pipe 42 with melt. In this embodiment of the present invention, there are two or more molding units 50 (only 1 shown in FIG. 4) positioned at the end of the melt pipe 42 with each having an independent inlet shutoff valve 49. The two or more molding units are depicted as n=2 or more in FIG. 4. In this manner of operation, the melt continuously flowing from the twin screw extruder 20 fills one or more of the molding units 50 during the filling phase through shutoff valve 49 while another molding unit 50 is in the injection phase with the shutoff valve 49 leading to it in the closed position. Having two or more molding units 50 downstream of the twin screw extruder eliminates the need for an intermediate melt reservoir between the twin screw extruder 20 and the molding unit 50. The multiple (n=2 or more) molding units 50 of FIG. 4 are alternatively filled with melt continuously being provided by the twin screw extruder 20.

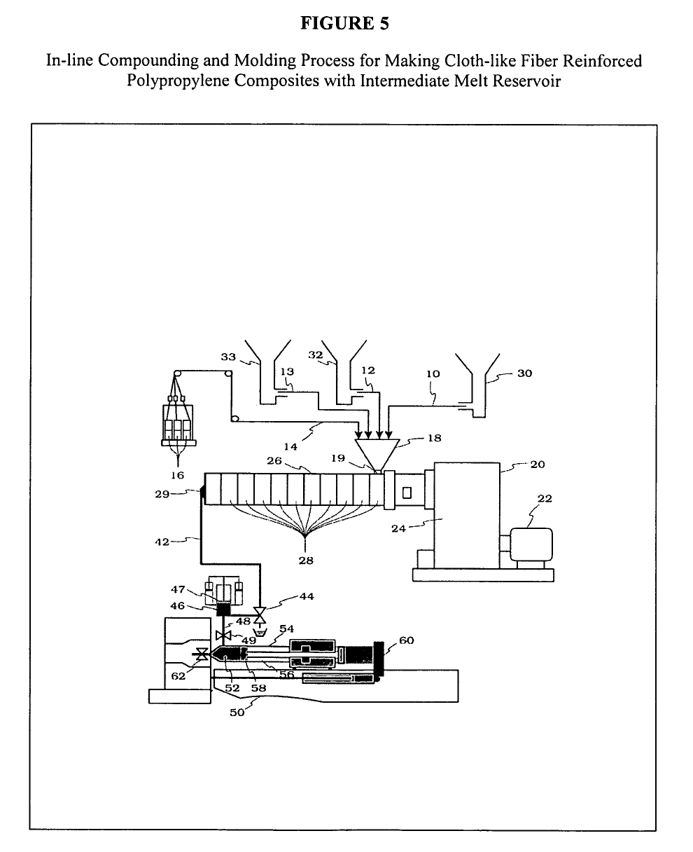

FIG. 5 depicts an exemplary schematic of the in-line compounding and molding process for making cloth-like fiber reinforced polypropylene composites of the instant invention. The process of FIG. 5 is similar to FIG. 1, except for additional hardware needed to feed the colorant fiber 13 to the twin screw extruder 20. FIG. 5 includes an intermediate melt reservoir 46 between the twin screw extruder 20 and the molding unit 50. Parts corresponding with those in FIG. 1 are denoted by identical reference numerals and may not be explained again. Polypropylene based resin 10, inorganic filler 12, colorant fiber 13, and organic reinforcing fiber 14 continuously unwound from one or more spools 16 are fed into the extruder hopper 18 of a twin screw compounding extruder 20. Colorant fiber 13 is preferably in the form of a masterbatch resin. The extruder hopper 18 is positioned above the feed throat 19 of the twin screw compounding extruder 20. The extruder hopper 18 may alternatively be provided with an auger (not shown) for mixing the polypropylene based resin 10 and the inorganic filler 12 prior to entering the feed throat 19 of the twin screw compounding extruder 20. In an alternative embodiment, as depicted in FIG. 2, the inorganic filler 12 and/or the colorant fiber 13 may be fed to the twin screw compounding extruder 20 at a downstream feed port 27 in the extruder barrel 26 positioned downstream of the extruder hopper 18 while the polypropylene based resin 10 and the organic reinforcing fiber 14 are still metered into the extruder hopper 18.

The polypropylene based resin 10 is metered to the extruder hopper 18 via a feed system 30 for accurately controlling the feed rate. Similarly, the inorganic filler 12 and colorant fiber 13 are metered to the extruder hopper 18 via feed systems 32, 33 for accurately controlling the feed rate. The feed systems 30, 32, 33 may be, but are not limited to, gravimetric feed system or volumetric feed systems. Gravimetric feed systems are particularly preferred for accurately controlling the weight percentage of polypropylene based resin 10, inorganic filler 12, and colorant fiber 13 being fed to the extruder hopper 18. The feed rate of organic reinforcing fiber 14 to the extruder hopper 18 is controlled by a combination of the extruder screw speed, number of fiber filaments and the thickness of each filament in a given fiber spool, and the number of fiber spools 16 being unwound simultaneously to the extruder hopper 18. The higher the extruder screw speed measured in revolutions per minute (rpms), the greater will be the rate at which organic reinforcing fiber 14 is fed to the twin screw compounding screw 20. The rate at which organic reinforcing fiber 14 is fed to the extruder hopper also increases with the greater the number of filaments within the organic reinforcing fiber 14 being unwound from a single fiber spool 16, the greater filament thickness, the greater the number fiber spools 16 being unwound simultaneously, and the rotations per minute of the extruder.

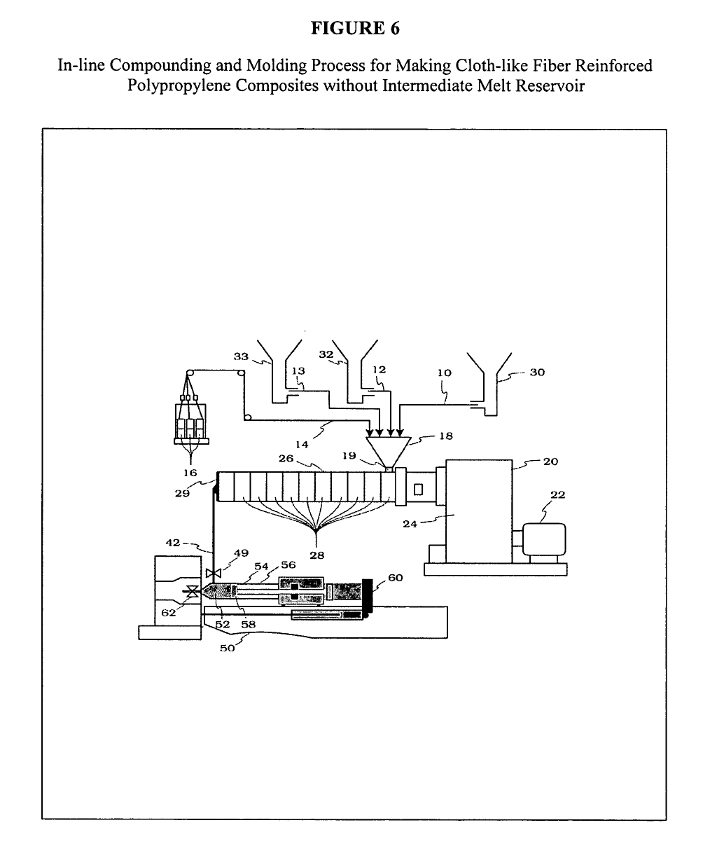

FIG. 6 depicts another exemplary schematic of the in-line compounding and molding process for making cloth-like fiber reinforced polypropylene composites of the instant invention. The process of FIG. 6 is similar to FIG. 4, except for additional hardware needed to feed the colorant fiber 13 to the twin screw extruder 20. The in-line compounding and molding machine of FIG. 6 includes a twin screw extruder 20 which is directly connected to the molding unit 50, without provision of an intermediate melt reservoir. Parts corresponding with those in FIG. 4 are denoted by identical reference numerals and may not be explained again. The feed throat 19 allows for the introduction of polypropylene based resin 10, organic reinforcing fiber 14, colorant fiber 13, and inorganic filler 12 into a feed zone of the twin screw compounding extruder 20. The inorganic filler 12 and colorant fiber 13 may be optionally fed to the extruder 20 at the downstream feed port 27.

FIG. 3 depicts the twin screw configuration 30 for use in the twin screw extruders of the in-line compounding and molding processes of FIGS. 1, 4, 5 and 6. The twin screws 30 include an arrangement of interconnected screw sections, including conveying elements 32 and kneading elements 34. The kneading elements 34 function to melt the polypropylene based resin, cut the organic reinforcing fiber lengthwise, and mix the polypropylene based melt, chopped organic reinforcing fiber, colorant fiber and inorganic filler to form a uniform blend. More particularly, the kneading elements function to break up the organic reinforcing fiber into about ⅛ inch to about 1 inch fiber lengths. A series of interconnected kneading elements 34 is also referred to as a kneading block. U.S. Pat. No. 4,824,256 to Haring, et al., herein incorporated by reference in its entirety, discloses co-rotating twin screw extruders with kneading elements. The first section of kneading elements 34 located downstream from the feed throat is also referred to as the melting zone of the twin screw compounding extruder 20. The conveying elements 32 function to convey the solid components, melt the polypropylene based resin, and convey the melt mixture of polypropylene based polymer, inorganic filler, colorant fiber and organic reinforcing fiber downstream toward the melt pipe 42 (see FIGS. 1, 4, 5, and 6) at a positive pressure.

The position of each of the screw sections as expressed in the number of diameters (D) from the start 36 of the extruder screws 30 is also depicted in FIG. 3. The extruder screws in FIG. 3 have a length to diameter ratio of 40/1, and at a position 32D from the start 36 of screws 30, there is positioned a kneading element 34. The particular arrangement of kneading and conveying sections is not limited to that as depicted in FIG. 3, however one or more kneading blocks consisting of an arrangement of interconnected kneading elements 34 may be positioned in the twin screws 30 at a point downstream of where organic fiber and inorganic filler are introduced to the extruder barrel. The twin screws 30 may be of equal screw length or unequal screw length. Other types of mixing sections may also be included in the twin screws 30, including, but not limited to, Maddock mixers, and pin mixers.

Among the benefits and advantages provided by the in-line compounding and molding process for making fiber reinforced polypropylene compositions of the instant invention are reduced production costs and reduced raw material costs, higher material and part quality, shorter molding cycle times, improved flexibility in part formulations, improved retention of fiber properties after processing, and improved temperature control for permitting reduced clamping forces during molding.

The present invention is further illustrated by means of the following examples, and the advantages thereto without limiting the scope thereof.

Test Methods

Fiber reinforced polypropylene compositions described herein were injection molded at 2300 psi pressure, 401° C. at all heating zones as well as the nozzle, with a mold temperature of 60° C.

Flexural modulus data was generated for injected molded samples produced from the fiber reinforced polypropylene compositions described herein using the ISO 178 standard procedure.

Instrumented impact test data was generated for injected mold samples produced from the fiber reinforced polypropylene compositions described herein using ASTM D3763. Ductility during instrumented impact testing (test conditions of 15 mph, −29° C., 25 lbs) is defined as no splintering of the sample.

### EXAMPLES

PP3505G is a propylene homopolymer commercially available from ExxonMobil Chemical Company of Baytown, Tex. The MFR (2.16 kg, 230° C.) of PP3505G was measured according to ASTM D1238 to be 400 g/10 min.

PP7805 is an 80 MFR propylene impact copolymer commercially available from ExxonMobil Chemical Company of Baytown, Tex.

PP8114 is a 22 MFR propylene impact copolymer containing ethylene-propylene rubber and a plastomer, and is commercially available from ExxonMobil Chemical Company of Baytown, Tex.

PP8224 is a 25 MFR propylene impact copolymer containing ethylene-propylene rubber and a plastomer, and is commercially available from ExxonMobil Chemical Company of Baytown, Tex.

PO1020 is 430 MFR maleic anhydride functionalized polypropylene homopolymer containing 0.5-1.0 weight percent maleic anhydride.

Cimpact CB7 is a surface modified talc and V3837 is a high aspect ratio talc, both available from Luzenac America Inc. of Englewood, Colo.

Granite Fleck is a masterbatch of dark polymer fiber in a linear low density carrier resin, and is commercially available from Uniform Color Company of Holland, Mich.

### Illustrative Examples 1-8

Varying amounts of PP3505G and 0.25″ long polyester reinforcing fibers obtained from Invista Corporation were mixed in a Haake single screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact under standard automotive conditions for interior parts (25 lbs, at 15 MPH, at −29° C.). The total energy absorbed and impact results are given in Table 1.

TABLE 1

| | | wt % | | |
|---|---|---|---|---|
| | wt % | Reinforcing | Total Energy | Instrumented |
| Example # | PP3505G | Fiber | (ft-lbf) | Impact Test Results |
| 1 | 65 | 35 | 8.6 ± 1.1 | ductile* |
| 2 | 70 | 30 | 9.3 ± 0.6 | ductile* |
| 3 | 75 | 25 | 6.2 ± 1.2 | ductile* |
| 4 | 80 | 20 | 5.1 ± 1.2 | ductile* |
| 5 | 85 | 15 | 3.0 ± 0.3 | ductile* |
| 6 | 90 | 10 | 2.1 ± 0.2 | ductile* |
| 7 | 95 | 5 | 0.4 ± 0.1 | brittle** |
| 8 | 100 | 0 | <0.1 | brittle*** |

*Examples 1-6: samples did not shatter or split as a result of impact, with no pieces coming off of the specimen.
**Example 7: pieces broke off of the sample as a result of the impact
***Example 8: samples completely shattered as a result of impact.

### Illustrative Examples 9-14

In Examples 9-11, 35 wt % PP7805, 20 wt % Cimpact CB7 talc, and 45 wt % 0.25″ long reinforcing polyester fibers obtained from Invista Corporation, were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact. The total energy absorbed and impact results are given in Table 2.

In Examples 12-14, PP8114 was extruded and injection molded under the same conditions as those for Examples 9-11. The total energy absorbed and impact results are given in Table 2.

TABLE 2

| | | | |
|---|---|---|---|
| | | Total | Instrumented |
| | Impact Conditions/Applied | Energy | Impact Test |
| Example # | Energy | (ft-lbf) | Results |

35 wt % PP7805 (70 MFR), 20 wt % talc, 45 wt % fiber

| | | | |
|---|---|---|---|
| 9 | −29° C., 15 MPH, 25 lbs/192 ft-lbf | 16.5 | ductile* |
| 10 | −29° C., 28 MPH, 25 lbs/653 ft-lbf | 14.2 | ductile* |
| 11 | −29° C., 21 MPH, 58 lbs/780 ft-lbf | 15.6 | ductile* |

100 wt % PP8114 (22 MFR)

| | | | |
|---|---|---|---|
| 12 | −29° C., 15 MPH, 25 lbs/192 ft-lbf | 32.2 | ductile* |
| 13 | −29° C., 28 MPH, 25 lbs/653 ft-lbf | 2.0 | brittle** |
| 14 | −29° C., 21 MPH, 58 lbs/780 ft-lbf | 1.7 | brittle** |

*Examples 9-12: samples did not shatter or split as a result of impact, with no pieces coming off of the specimen.
**Examples 13-14: samples shattered as a result of impact.

### Illustrative Examples 15-16

A Leistritz ZSE27 HP-60D 27 mm twin screw extruder with a length to diameter ratio of 40:1 was fitted with six pairs of kneading elements 12″ from the die exit. The die was ¼″ in diameter. Strands of continuous 27,300 denier PET reinforcing fibers were fed directly from spools into the hopper of the extruder, along with PP7805 and talc. The kneading elements in the extruder broke up the reinforcing fiber in situ. The extruder speed was 400 revolutions per minute, and the temperatures across the extruder were held at 190° C. Injection molding was done under conditions similar to those described for Examples 1-14. The mechanical and physical properties of the sample were measured and are compared in Table 3 with the mechanical and physical properties of PP8224.

The instrumented impact test showed that in both examples there was no evidence of splitting or shattering, with no pieces coming off the specimen. In the notched charpy test, the PET fiber-reinforced PP7805 specimen was only partially broken, and the PP8224 specimen broke completely.

TABLE 3

| | Example 15 | |
|---|---|---|
| Test | PET fiber-reinforced | Example 16 |
| (Method) | PP7805 with talc | PP8224 |
| Flexural Modulus, Chord | 525,190 psi | 159,645 psi |
| (ISO 178) | | |
| Instrumented Impact at −30° C. | 6.8 J | 27.5 J |
| Energy to maximum load | | |
| 100 lbs at 5 MPH | | |
| (ASTM D3763) | | |
| Notched Charpy Impact at −40° C. | 52.4 kJ/m² | 5.0 kJ/m² |
| (ISO 179/1 eA) | | |
| Heat Deflection Temperature | 116.5° C. | 97.6° C. |
| at 0.45 Mpa, edgewise | | |
| (ISO 75) | | |
| Coefficient of Linear Thermal | 2.2/12.8 | 10.0/18.6 |
| Expansion, −30° C. to 100° C., | (E-5/° C.) | (E-5/° C.) |
| Flow/Crossflow | | |
| (ASTM E831) | | |

### Illustrative Examples 17-18

In Examples 17-18, 30 wt % of either PP3505G or PP8224, 15 wt % 0.25″ long polyester reinforcing fibers obtained from Invista Corporation, and 45 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 4.

TABLE 4

| | | | Instrumented Impact |
|---|---|---|---|
| | | | at −30° C. |
| | | | Energy to maximum |
| | | Flexural Modulus, | load |
| | | Chord, psi | 25 lbs at 15 MPH |
| Example | Polypropylene, | (ISO 178) | (ASTM D3763), ft-lb |
| 17 | PP8224 | 433840 | 2 |
| 18 | PP3505 | 622195 | 2.9 |

The rubber toughened PP8114 matrix with PET reinforcing fibers and talc displayed lower impact values than the PP3505 homopolymer. This result is surprising, because the rubber toughened matrix alone is far tougher than the low molecular weight PP3505 homopolymer alone at all temperatures under any conditions of impact. In both examples above, the materials displayed no splintering.

### Illustrative Examples 19-24

In Examples 19-24, 25-75 wt % PP3505G, 15 wt % 0.25″ long polyester reinforcing fibers obtained from Invista Corporation, and 10-60 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 5.

TABLE 5

| | | Flexural Modulus, |
|---|---|---|
| Example | Talc Composition, | Chord, psi (ISO 178) |
| 19 | 10% | 273024 |
| 20 | 20% | 413471 |
| 21 | 30% | 583963 |
| 22 | 40% | 715005 |
| 23 | 50% | 1024394 |
| 24 | 60% | 1117249 |

It is important to note that in examples 19-24, the samples displayed no splintering in drop weight testing at an −29 C, 15 miles per hour at 25 pounds.

### Illustrative Examples 25-26

Two materials, one containing 10% ¼ inch polyester reinforcing fibers, 35% PP3505 polypropylene and 60% V3837 talc (example 25), the other containing 10% ¼ inch polyester reinforcing fibers, 25% PP3505 polypropylene homopolymer (example 26), 10% PO1020 modified polypropylene were molded in a Haake twin screw extruder at 175° C. They were injection molded into standard ASTM A370 ½ inch wide sheet type tensile specimens. The specimens were tested in tension, with a ratio of minimum to maximum load of 0.1, at flexural stresses of 70 and 80% of the maximum stress.

TABLE 6

| | Percentage of | | |
|---|---|---|---|
| | Maximum Stress to | Example 25, | Example 26, |
| Example | Yield Point | Cycles to failure | Cycles to failure |
| 25 | 70 | 327 | 9848 |
| 26 | 80 | 30 | 63 |

The addition of the modified polypropylene is shown to increase the fatigue life of these materials

### Illustrative Examples 27-29

A Leistritz 27 mm co-rotating twin screw extruder with a ratio of length to diameter of 40:1 was used in these experiments. The process configuration utilized was as depicted in FIG. 1. The screw configuration used is depicted in FIG. 3, and includes an arrangement of conveying and kneading elements. Talc, polypropylene and PET reinforcing fiber were all fed into the extruder feed hopper located approximately two diameters from the beginning of the extruder screws (19 in the FIG. 3). The PET reinforcing fiber was fed into the extruder hopper by continuously feeding from multiple spools a fiber tow of 3100 filaments with each filament having a denier of approximately 7.1. Each filament was 27 microns in diameter, with a specific gravity of 1.38.

The twin screw extruder ran at 603 rotations per minute. Using two gravimetric feeders, PP7805 polypropylene was fed into the extruder hopper at a rate of 20 pounds per hour, while CB 7 talc was fed into the extruder hopper at a rate of 15 pounds per hour. The PET reinforcing fiber was fed into the extruder at 12 pounds per hour, which was dictated by the screw speed and tow thickness. The extruder temperature profile for the ten zones 144° C. for zones 1-3, 133° C. for zone 4, 154° C. for zone 5, 135° C. for zone 6, 123° C. for zones 7-9, and 134° C. for zone 10. The strand die diameter at the extruder exit was ¼ inch.

The extrudate was quenched in an 8 foot long water trough and pelletized to ½ inch length to form PET/PP composite pellets. The extrudate displayed uniform diameter and could easily be pulled through the quenching bath with no breaks in the water bath or during instrumented impact testing. The composition of the PET/PP composite pellets produced was 42.5 wt % PP, 25.5 wt % PET, and 32 wt % talc.

The PET/PP composite resin produced was injection molded and displayed the following properties:

TABLE 7

| | Example 27 |
|---|---|
| Specific Gravity | 1.3 |
| Tensile Modulus, Chord @ 23° C. | 541865 psi |
| Tensile Modulus, Chord @ 85° C. | 257810 psi |
| Flexural Modulus, Chord @ 23° C. | 505035 psi |
| Flexural Modulus, Chord @ 85° C. | 228375 psi |
| HDT @ 0.45 MPA | 116.1° C. |
| HDT @ 1.80 MPA | 76.6° C. |
| Instrumented impact @ 23° C. | 11.8 J D** |
| Instrumented impact @ −30° C. | 12.9 J D** |

**Ductile failure with radial cracks

In example 28, the same materials, composition, and process set-up were utilized, except that extruder temperatures were increased to 175° C. for all extruder barrel zones. This material showed complete breaks in the instrumented impact test both at 23° C. and −30° C. Hence, at a barrel temperature profile of 175° C., the mechanical properties of the PET reinforcing fiber were negatively impacted during extrusion compounding such that the PET/PP composite resin had poor instrumented impact test properties.

In example 29, the fiber was fed into a hopper placed 14 diameters down the extruder (27 in the FIG. 3). In this case, the extrudate produced was irregular in diameter and broke an average once every minute as it was pulled through the quenching water bath. When the PET reinforcing fiber tow is continuously fed downstream of the extruder hopper, the dispersion of the PET in the PP matrix was negatively impacted such that a uniform extrudate could not be produced, resulting in the irregular diameter and extrudate breaking.

### Illustrative Example 30

An extruder with the same size and screw design as examples 27-29 was used. All zones of the extruder were initially heated to 180° C. PP 3505 dry mixed with Jetfine 700 C and PO 1020 was then fed at 50 pounds per hour using a gravimetric feeder into the extruder hopper located approximately two diameters from the beginning of the extruder screws. Polyester reinforcing fiber with a denier of 7.1 and a thickness of 3100 filaments was fed through the same hopper. The screw speed of the extruder was then set to 596 revolutions per minute, resulting in a feed rate of 12.1 pounds of fiber per hour. After a uniform extrudate was attained, all temperature zones were lowered to 120° C., and the extrudate was pelletized after steady state temperatures were reached. The final composition of the blend was 48% PP 3505, 29.1% Jetfine 700 C, 8.6% PO 1020 and 14.3% polyester reinforcing fiber.

The PP composite resin produced while all temperature zones of the extruder were set to 120° C. was injection molded and displayed the following properties:

TABLE 8

| | Example 30 |
|---|---|
| Flexural Modulus, Chord @ 23° C. | 467,932 psi |
| Instrumented impact @ 23° C. | 8.0 J D** |
| Instrumented impact @ −30° C. | 10.4 J D** |

**Ductile failure with radial cracks

### Illustrative Examples 31-34

4% Granite Fleck, which is a masterbatch of dark polymer fiber in a low density polyethylene carrier resin, was extrusion compounded with a twin screw extruder into both polypropylene based impact copolymer (PP 8114) (control sample) and also into a blend of PP homopolymer/PET fiber/talc (40% PP3505G polypropylene, 15% Invista PET reinforcing fiber (¼″ length), and 41% Luzenac Jetfine 3CA talc) (embodiment of present invention). Corresponding resin samples without the incorporation of the colorant fiber masterbatch (no Granite Fleck) were also produced to assess the impact of the colorant fiber on impact properties for the prior art PP impact copolymer and the PP-PET fiber reinforced composite of the present invention. The fiber reinforced polypropylene composite without the colorant fiber included 40% PP3505G polypropylene, 15% Invista PET reinforcing fiber (¼″ length), and 45% Luzenac Jetfine 3CA talc.

These four resin samples were molded in accordance with the geometry of ASTM D3763 and tested for instrumented impact resistance and failure mode upon impact failure. The instrumented impact test results are given in Table 9.

TABLE 9

| | | | Failure mode | |
|---|---|---|---|---|
| | | Instrumented | during | Flexural |
| Ex- | Material | impact (ft- | instrumented | modulus |
| ample | Composition | lbs) | impact | (psi) |
| 31 | Impact copolymer | 32.2 | Ductile | No data |
| | (PP 8114) (prior art | | | |
| | control w/o colorant | | | |
| | fiber) | | | |
| 32 | Impact copolymer + | 4.1 | Brittle | No data |
| | colorant fiber (PP | | | |
| | 8114 + 4% Granite | | | |
| | Fleck) (prior art | | | |
| | control w/colorant | | | |
| | fiber) | | | |
| 33 | PP/PET fiber/talc | 11.9 | Ductile | 609,000 |
| | composite (40% PP | | | |
| | 3505G/15% PET | | | |
| | fiber/45% talc) | | | |
| | (present invention | | | |
| | w/o colorant fiber) | | | |
| 34 | PP/PET | 12.6 | Ductile | 606,000 |
| | fiber/talc/colorant | | | |
| | fiber composite (40% | | | |
| | PP 3505G/15% PET | | | |
| | fiber/41% talc/4% | | | |
| | Granite Fleck) | | | |
| | (present invention + | | | |
| | colorant fiber) | | | |

From Table 9, it is important to note that upon the incorporation of the colorant fiber into the impact polymer (Example 32) of the prior art, there is approximately a 88% decrease in instrumented impact resistance, and also the failure mode goes from ductile (no splintering) to brittle (splintering). In contrast, when colorant fiber is added to the PP/PET fiber/talc composition material (Example 34) of the present invention, there is no decrease in instrumented impact resistance, while the failure mode remains ductile in nature, with negligible reduction in flexural modulus. The PP/PET fiber/talc/colorant fiber composite material after molding also has a cloth-like look to it from the incorporation of the dark colorant fiber uniformly dispersed through the molded object. Surprisingly, the PP/PET fiber/talc/colorant fiber composite material (Example 34) retains its outstanding impact resistance unlike the prior art rubber modified PP impact copolymer/colorant fiber sample (Example 32).

All patents, test procedures, and other documents cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which the invention pertains.

When numerical lower limits and numerical upper limits are listed herein, ranges from any lower limit to any upper limit are contemplated.

What is claimed is:

1. An in-line compounding and molding process for making a fiber reinforced polypropylene part, the process comprising the following steps:
(a) providing an in-line compounding and molding machine comprising a twin screw extruder fluidly coupled to an injection molder;
(b) extrusion compounding in the twin screw extruder a composition comprising at least 30 wt % polypropylene, from 10 to 60 wt % organic fiber, from 0 to 40 wt % inorganic filler, and from 0 to 0.1 wt % lubricant, based on the total weight of the composition, to form a melt extrudate;
(c) conveying the melt extrudate to the injection molder; and
(d) molding the melt extrudate in the injection molder to form a part having a flexural modulus of at least 300,000 psi and exhibiting ductility during instrumented impact testing.

2. The process of claim 1, wherein said in-line compounding and molding machine further comprises an intermediate melt reservoir between the twin screw extruder and the injection molder.

3. The process of claim 1, wherein said injection molder comprises two or more injection devices which are alternatively filled with the melt extrudate from the twin screw extruder.

4. The process of claim 1, wherein the organic fiber is cut prior to the extrusion compounding step.

5. The process of claim 1, wherein during the extrusion compounding step, the organic fiber is a continuous fiber and is fed directly from one or more spools into an extruder hopper.

6. An automotive part made by the process of claim 1.

7. The automotive part of claim 6, wherein the automotive part is an automobile bumper, aesthetic trim part, body panel, under body part, under hood part, door core, steering wheel cover, head liner panel, dashboard panel, interior door trim panel, pillar trim cover panel, or under-dashboard panel.

8. An in-line compounding and molding process for making a fiber reinforced polypropylene article comprising:
(a) at least 30 wt %, based on the total weight of the composition, polypropylene;
(b) from 10 to 60 wt %, based on the total weight of the composition, organic fiber;
(c) from 0 to 40 wt %, based on the total weight of the composition, inorganic filler; and
(d) from 0 to 0.1 wt %, based on the total weight of the composition, lubricant;
wherein the composition has a flexural modulus of at least 400,000 psi, and exhibits ductility during instrumented impact testing,
wherein the process comprises the following steps:
(a) providing an in-line compounding and molding machine comprising a twin screw extruder fluidly coupled to an injection molder;
(b) extrusion compounding the composition in the twin screw extruder to form a melt extrudate;
(c) conveying the melt extrudate to the injection molder; and
(d) molding the melt extrudate in the injection molder to form the article.

9. The process of claim 8, wherein said in-line compounding and molding machine further comprises an intermediate melt reservoir between the twin screw extruder and the injection molder.

10. The process of claim 8, wherein said injection molder comprises two or more injection devices which are alternatively filled with the melt extrudate from the twin screw extruder.

11. The process of claim 8, wherein the organic fiber is cut prior to the extrusion compounding step.

12. The process of claim 8, wherein during the extrusion compounding step, the organic fiber is a continuous fiber and is fed directly from one or more spools into an extruder hopper.

13. An automotive part made by the process of claim 8.

14. The automotive part of claim 13, wherein the automotive part is an automobile bumper, aesthetic trim part, body panel, under body part, under hood part, door core, steering wheel cover, head liner panel, dashboard panel, interior door trim panel, pillar trim cover panel, or under-dashboard panel.

15. An in-line compounding and molding process for making fiber reinforced polypropylene composite articles comprising the following steps:
(a) providing an in-line compounding and molding machine comprising a twin screw extruder fluidly coupled to an injection molder,
(b) feeding into said twin screw extruder hopper at least about 25 wt % of a polypropylene based resin with a melt flow rate of from about 20 to about 1500 g/10 minutes,
(c) continuously feeding by unwinding from one or more spools into said twin screw extruder hopper from about 5 wt % to about 40 wt % of an organic fiber,
(d) feeding into a twin screw extruder from about 10 wt % to about 60 wt % of an inorganic filler,
(e) extruding said polypropylene based resin, said organic fiber, and said inorganic filler through said twin screw extruder to form a fiber reinforced polypropylene composite melt,
(f) conveying said fiber reinforced polypropylene composite melt to said injection molder, and
(g) molding said fiber reinforced polypropylene composite melt to form a fiber reinforced polypropylene composite article.

16. The process of claim 15, wherein said in-line compounding and molding machine further comprises an intermediate melt reservoir between the twin screw extruder and the injection molder.

17. The process of claim 15, wherein said injection molder comprises two or more injection devices which are alternatively filled with the melt extrudate from the twin screw extruder.

18. The process of claim 15 wherein said article has a flexural modulus of at least about 300,000 psi and exhibits ductility during instrumented impact testing.

19. The process of claim 15 wherein said polypropylene based resin is selected from the group consisting of polypropylene homopolymers, propylene-ethylene random copolymers, propylene-α-olefin random copolymers, propylene impact copolymers, and combinations thereof.

20. The process of claim 19 wherein said polypropylene based resin is polypropylene homopolymer with a melt flow rate of from about 150 to about 1500 g/10 minutes.

21. The process of claim 15 wherein said polypropylene based resin further comprises from about 0.1 wt % to less than about 10 wt % of a polypropylene based polymer modified with a grafting agent, wherein said grafting agent is selected from the group consisting of acrylic acid, methacrylic acid, maleic acid, itaconic acid, fumaric acid or esters thereof, maleic anhydride, itaconic anhydride, and combinations thereof.

22. The process of claim of claim 15 further comprising the step of feeding from about 0.01 to about 0.1 wt % lubricant, based on the total weight of the fiber reinforced polypropylene composite pellets, wherein said lubricant is selected from the group consisting of silicon oil, silicon gum, fatty amide, paraffin oil, paraffin wax, and ester oil.

23. The process of claim 15 wherein said organic fiber is selected from the group consisting of polyalkylene terephthalates, polyalkylene naphthalates, polyamides, polyolefins, polyacrylonitrile, and combinations thereof.

24. The process of claim 23 wherein said organic fiber is polyethylene terephthalate.

25. The process of claim 15 wherein said inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

26. The process of claim 25 wherein said inorganic filler is talc or wollastonite.

27. The process of claim 15 wherein said twin screw extruder comprises two extruder screws configured with interconnected screw elements to have a feed zone, a melting zone, one or more mixing sections, one or more decompression sections and one or more conveying sections.

28. The process of claim 27 wherein said one or more mixing sections comprise one or more kneading blocks positioned along the length of said two extruder screws.

29. The process of claim 28 wherein said one or more kneading blocks comprise a series of interconnected kneading elements.

30. The process of claim 28 wherein said one or more mixing sections break up said organic fiber into about ⅛ inch to about 1 inch fiber lengths.

31. The process of claim 15 wherein said twin screw extruder comprises barrel temperature control zone set points of less than or equal to 210° C.

32. The process of claim 31 wherein said twin screw extruder comprises barrel temperature control zone set points of less than or equal to 185° C.

33. The process of claim 15 wherein said fiber reinforced composite article has a flexural modulus of at least about 300,000 psi and exhibits ductility during instrumented impact testing.

34. An in-line compounding and molding process for making fiber reinforced polypropylene composite articles comprising:
(a) at least 30 wt %, based on the total weight of the composition, polypropylene based polymer;
(b) from 10 to 60 wt %, based on the total weight of the composition, organic reinforcing fiber;
(c) from 0 to 40 wt %, based on the total weight of the composition, inorganic filler; and
(d) from 0.1 to 2.5 wt %, based on the total weight of the composition, colorant fiber;
wherein said article molded from said composition has a flexural modulus of at least 300,000 psi, exhibits ductility during instrumented impact testing, and exhibits a cloth-like appearance; wherein said process comprises the steps of:
(a) providing an in-line compounding and molding machine comprising a twin screw extruder fluidly coupled to an injection molder;
(b) extrusion compounding the composition in the twin screw extruder to form a melt extrudate;
(c) conveying the melt extrudate to the injection molder; and
(d) molding the melt extrudate in the injection molder to form the article.

35. The process of claim 34, wherein said in-line compounding and molding machine further comprises an intermediate melt reservoir between the twin screw extruder and the injection molder.

36. The process of claim 34, wherein said injection molder comprises two or more injection devices which are alternatively filled with the melt extrudate from the twin screw extruder.

37. The process of claim 34 wherein said molding step further comprises the step of providing a mold with a textured surface, wherein said article further exhibits a cloth-like feel.

38. The process of claim 34, wherein said organic reinforcing fiber is cut prior to the twin screw extrusion compounding step.

39. The process of claim 34, wherein during said twin screw extrusion compounding step, the organic fiber is a continuous fiber and is fed directly from one or more spools into an extruder hopper.

40. An automotive part made by the process of claim 34.

41. The automotive part of claim 40, wherein said automotive part is an interior trim cover panel selected from the group consisting of a steering wheel cover, a head liner panel, a dashboard panel, an interior door trim panel, a pillar trim cover panel, or an under-dashboard panel.

42. An in-line compounding and molding process for making a fiber reinforced polypropylene resin composition comprising:
(a) at least 25 wt %, based on the total weight of the composition, polypropylene based polymer with a melt flow rate of from about 20 to about 1500 g/10 minutes;
(b) from 5 to 40 wt %, based on the total weight of the composition, organic reinforcing fiber;
(c) from 10 to 60 wt %, based on the total weight of the composition, inorganic filler; and
(d) from 0.1 to 2.5 wt %, based on the total weight of the composition, colorant fiber;
wherein an article molded from said composition has a flexural modulus of at least about 300,000 psi, exhibits ductility during instrumented impact testing, and exhibits a cloth-like appearance; wherein said process comprises the steps of:
(a) providing an in-line compounding and molding machine comprising a twin screw extruder fluidly coupled to an injection molder,
(b) feeding into said twin screw extruder hopper said polypropylene based polymer,
(c) continuously feeding by unwinding from one or more spools into said twin screw extruder hopper said organic reinforcing fiber;
(d) extruding said polypropylene based resin, said organic reinforcing fiber, said inorganic filler, and said colorant fiber through said twin screw extruder to form a fiber reinforced polypropylene composite melt;
(e) conveying said fiber reinforced polypropylene composite melt to said injection molder, and
(f) molding said fiber reinforced polypropylene composite melt to form a fiber reinforced polypropylene composite article.

43. The process of claim 42, wherein said in-line compounding and molding machine further comprises an intermediate melt reservoir between the twin screw extruder and the injection molder.

44. The process of claim 42, wherein said injection molder comprises two or more injection devices which are alternatively filled with the melt extrudate from the twin screw extruder.

45. The process of claim 42 wherein said polypropylene based resin is selected from the group consisting of polypropylene homopolymers, propylene-ethylene random copolymers, propylene-α-olefin random copolymers, propylene impact copolymers, and combinations thereof.

46. The process of claim 42 wherein said polypropylene based resin is polypropylene homopolymer with a melt flow rate of from about 150 to about 1500 g/10 minutes.

47. The process of claim 42 wherein said organic reinforcing fiber is selected from the group consisting of polyalkylene terephthalates, polyalkylene naphthalates, polyamides, polyolefins, polyacrylonitrile, and combinations thereof.

48. The process of claim 47 wherein said organic reinforcing fiber is polyethylene terephthalate.

49. The process of claim 42 wherein said inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

50. The process of claim 49 wherein said inorganic filler is talc or wollastonite.

51. The process of claim 42 wherein said colorant fiber includes an inorganic pigment, an organic dye, or a combination thereof.

52. The process of claim 51 wherein said colorant fiber is selected from the group consisting of cellulosic fiber, acrylic fiber, nylon type fiber, polyester type fiber, and combinations thereof.

53. The process of claim 52 wherein said polypropylene based polymer further comprises an inorganic pigment, an organic dye, or a combination thereof.

54. The process of claim 42 wherein said colorant fiber is in the form of a masterbatch comprising a carrier resin selected from the group consisting of polypropylene homopolymer, ethylene-propylene copolymer, ethylene-propylene-butene-1 terpolymer, propylene-butene-1 copolymer, low density polyethylene, high density polyethylene, and linear low density polyethylene.

55. The process of claim 42 wherein said twin screw extruder comprises barrel temperature control zone set points of less than or equal to 210° C.

56. The process of claim 55 wherein said twin screw extruder comprises barrel temperature control zone set points of less than or equal to 185° C.

57. An automotive part made by the process of claim 42.

58. The automotive part of claim 57, wherein said automotive part is an interior trim cover panel selected from the group consisting of a steering wheel cover, a head liner panel, a dashboard panel, an interior door trim panel, a pillar trim cover panel, or an under-dashboard panel.
